(19) United States
(12) Patent Application Publication
(10) Pub. No.: US 2016/0055755 A1
(43) Pub. Date: Feb. 25, 2016

(54) SQUEEZABLE ALPHABET EDUCATIONAL TOY

(71) Applicant: Glen Hawkins, Kalamazoo, MI (US)

(72) Inventor: Glen Hawkins, Kalamazoo, MI (US)

(21) Appl. No.: 14/465,943

(22) Filed: Aug. 22, 2014

(51) Int. Cl. G09B 5/06; G09B 23/02; G09B 19/00

(52) U.S. Cl. CPC G09B 5/06; G09B 19/00; G09B 23/02

(57) ABSTRACT

A squeezable educational toy comprising a shaped housing, where the shaped housing includes an outer surface; a noise box within the housing, where the noise box is battery powered; an actuator button on the noise box; and a series of sounds created from the noise box, where the series of sounds are initiated by pressing the actuator button on the noise box, and where the series of sounds correspond to the shape of the housing. With the squeezable educational toy a user is able to learn both visually and auditorily about the alphabet.

### BACKGROUND OF THE INVENTION

1. Field of the Invention

The present invention relates to a toy shaped as a letter of the alphabet, where the shaped toy sounds to teach the child about the specific letter.

2. Description of Related Art

Young children, within their early developmental years, are like sponges to absorb information. As they are learning the basic shapes, colors, and sounds this is also the ideal time for the child to learn language. Language is a complex system of communication that must be learned during the early developmental years. Once a child begins to learn basic words they may also start to learn the letters that are combined to create these essential language tools. By simply speaking, adults around the child impart their language, and the child learns to communicate by speech.

To assist the parents with teaching language and the alphabet, some toys and tools have been developed. One of the most popular toys is letter blocks, where each block has a letter inscribed on it. The child is able to learn what the letters look like, and with help from an adult they may view the arranged letters to create words. Similarly, magnetic or foam letters are available for arrangement on the floor or a magnetic board. Individual letters and words are presented as an educational lesson. While these letters are useful, a parent or adult is necessary to teach and show the child which letter is represented and how it may be used in a group. Therefore it would be beneficial in the art to provide an educational toy that offers both group and individual play options.

### SUMMARY OF THE INVENTION

In view of the foregoing disadvantages inherent in the prior art, the general purpose of the present invention is to provide a squeezable toy to teach the alphabet, configured to include all of the advantages of the prior art, and to overcome the drawbacks inherent therein.

Accordingly, an object of the present invention is to provide a squeezable educational toy each toy representing a letter of the alphabet. The toy includes an internal noise box to say various messages associated with the corresponding letter.

To achieve the above objects, in an aspect of the present invention, a squeezable educational toy is described comprising a shaped housing, where the shaped housing includes an outer surface; a noise box within the housing, where the noise box is battery powered; an actuator button on the noise box; and a series of sounds created from the noise box, where the series of sounds are initiated by pressing the actuator button on the noise box, and where the series of sounds correspond to the shape of the housing. With the squeezable educational toy a user is able to learn both visually and auditorily about the alphabet.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a squeezable alphabet educational toy in accordance with an exemplary embodiment of the present invention; and

FIG. 2 depicts a perspective view of a series of letters in accordance with an exemplary embodiment of the present invention.

Like reference numerals refer to like parts throughout the description of several views of the drawings.

### DETAILED DESCRIPTION OF THE DRAWINGS

The present invention relates to a toy shaped as a letter of the alphabet, where the shaped toy sounds to teach the child about the specific letter. The present invention provides a squeezable alphabet educational toy to facilitate the early learning process for young children. The squeezable alphabet educational toy is a handheld letter with a soft-texture feel. The letter includes an internal noise box that when pressed creates a sound. The sound teaches the child about the letter to better develop the child's understanding of the alphabet. With the squeezable alphabet educational toy the colorful letters captures the child's attention while simultaneously teaching them about the individual letters.

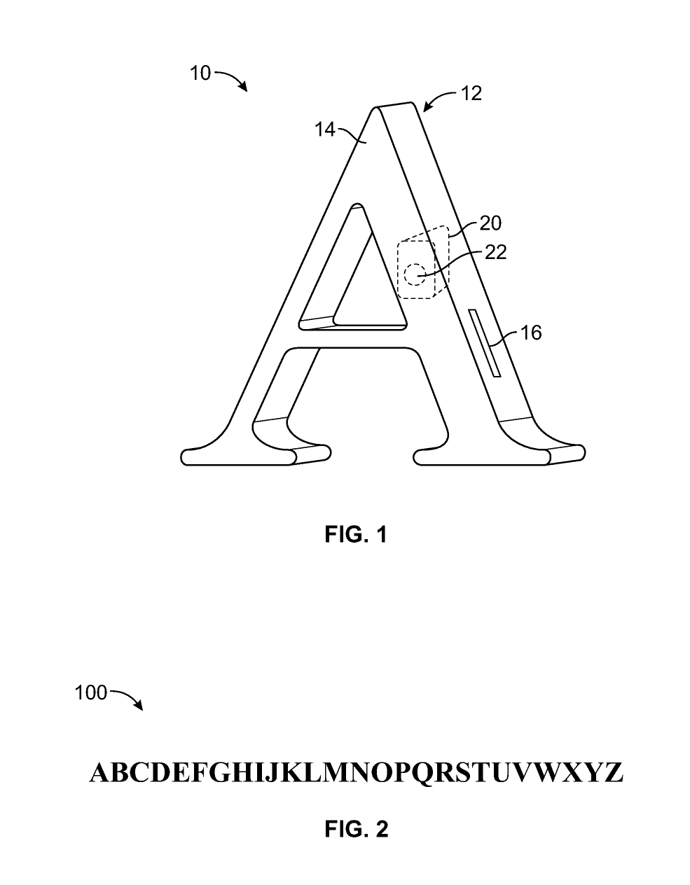

Turning now descriptively to the drawings, referring to FIG. 1, a squeezable alphabet educational toy 10 is shown in accordance with an exemplary embodiment of the present invention. The squeezable alphabet educational toy 10 includes a housing 12. The housing 12 is shaped as a letter of the alphabet, where each letter has rounded edges. The housing 12 includes an outer surface 14 available in a plurality of colors depending on the likes and preferences of the user. The outer surface 14 may be textured and covered with a non-toxic, slip-resistant, material for a squeezable soft feel. The outer surface 114 may be a soft rubber, plastic, vinyl, silicone, cotton, neoprene or similar material. The housing 12 may measure 2-12 inches in height where the preferred height is 2.25 inches. The width may vary depending on the specific letter represented. The outer surface 14 may be waterproof to enable easy wiping and cleaning between uses.

Within the housing 12 may be a noise box 20. The noise box 20 includes an actuator button 22 that when pressed the noise box 20 is programmed to create a sound. The sound may be one of a series of educational sounds relating to the corresponding letter represented by the housing 12. The sound may recite the letter, the pronunciation of the letter, a word beginning with the letter, a sentence including the word beginning with the letter or an alliterative sentence where all or most words begin with the letter. Each time the actuator button 22 is pressed a new sound is heard in the series where first the pronunciation is heard, then the word and finally the sentence. The words and sentences may be in English but also different noise boxes may be programmed to recite a foreign language like Spanish, French, German, Italian, or any other languages that use the Latin alphabet.

On a side of the housing 12 may be an opening 16. The opening 16 enables the noise box 20 to be extracted from the housing 12. The opening 16 may include a closure like a hook and loop fastener. During use, the opening 16 remains closed until the user opens it to remove the noise box 20. The noise box 20 may be battery operated with a long lasting lithium battery. The batteries may be replaced as needed by removing the noise box 20 from the opening 16.

In FIG. 1 the housing 12 embodies an A, but as illustrated in FIG. 2, the housing 12 may be any letter of the alphabet 100, A-Z. One of each letter of the alphabet 100 may be represented by separate housing 12 to create a toy set. Additionally, the housing 12 may be shaped as a number ranging from 0-9. The font of the letters of the alphabet 100 may be century school book fonts so that they are easily recognizable. By hearing all the different aspects of the letter and how to use it, the child use is able to quickly absorb and learn the alphabet. With the squeezable educational toy a user is able to learn both visually and auditorily about the alphabet, thereby creating a permanent learning association.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A squeezable educational toy comprising:
a. a shaped housing, where the shaped housing includes an outer surface;
b. a noise box within the housing, where the noise box is battery powered;
c. an actuator button on the noise box; and
d. a series of sounds created from the noise box, where the series of sounds are initiated by pressing the actuator button on the noise box, and where the series of sounds correspond to the shape of the housing.

2. A squeezable educational toy according to claim 1, where the shaped housing is shaped as a letter of the alphabet.

3. A squeezable educational toy according to claim 2, where the series of sounds includes:
a. a recitation of the letter represented by the housing;
b. a recitation of the pronunciation of the letter;
c. a word starting with the letter; and
d. a sentence including the word starting with the letter.

4. A squeezable educational toy according to claim 3, where the series of sounds further includes an alliterative sentence including the letter.

5. A squeezable educational toy according to claim 1, where the shaped housing is shaped as a number.

6. A squeezable educational toy according to claim 1, where the outer surface is made from one of at least rubber, plastic, vinyl, silicone, cotton or neoprene.

7. A squeezable educational toy according to claim 1, where the housing includes an opening to remove the noise box.

8. A squeezable educational toy according to claim 7, where the opening includes a closure, where the closure is a hook and loop fastener.

9. A squeezable educational toy according to claim 1, where the squeezable educational toy is a toy set, where the toy set includes a housing to represent each letter of the alphabet.

10. A squeezable educational toy according to claim 1, where the squeezable educational toy is a toy set, where the toy set includes a housing to represent each number 0-9.
